(19) United States
(12) Patent Application Publication
(10) Pub. No.: US 2009/0061986 A1
(43) Pub. Date: Mar. 5, 2009

(54) Slot Machine Displaying Game Images

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/202,765

(22) Filed: Sep. 2, 2008

(30) Foreign Application Priority Data
Sep. 3, 2007 (JP) JP2007-227589

(51) Int. Cl. A63F 9/24; A63F 13/00

(52) U.S. Cl. 463/20; 463/27

(57) ABSTRACT

A slot machine stores gaming images of a liquid crystal panel 5B. However, if total payout amount awarded in a unit game of a slot game and each unit game of a free game following the unit game does not exceed the recorded highest amount, gaming images showing the series of unit games are erased. Meanwhile, if total values of payout amounts awarded in a unit game of a slot game and each unit game of a free game following the unit game exceeds the recorded highest amount, the gaming images showing the series of unit games are replayed during a demonstration period after that. In addition, to the replayed image, an execution time display portion 18 showing the date-and-time when the series of unit games is executed is composed.

### CROSS-REFERENCE TO RELATED APPLICATIONS

This application is based upon and claims a priority from the prior Japanese Patent Application No. 2007-227589 filed on Sep. 3, 2007, the entire contents of which are incorporated herein by reference.

### BACKGROUND

1. Field

The present invention relates to a slot machine displaying game images.

2. Description of Related Art

While a conventional slot machine displays images of an ongoing game on the slot machine, it does not display those of games that have been executed on the slot machine before.

As art document information related to the conventional slot machine, there is U.S. Pat. No. 6,174,233B1.

Accordingly, a player cannot confirm with actual images whether or not a high payout game has really been executed on that slot machine. Thus, as the player cannot actually see past histories of the slot machine, the player becomes anxious, thinking that a high payout may not be really won on that slot machine. Further, a game arcade that has installed the slot machine cannot eliminate anxieties of the player who adheres to such actual images.

### SUMMARY

The present invention has been made in light of the above, and it is an object of the invention to provide an unprecedented novel slot machine characterized by increasing credibility of awarding a high payout.

To achieve the object of the disclosure, there is provided a slot machine, comprising: an input device with which a player executes a game operation; a display on which an image of a slot game is displayed based on the game operation of the player with the input device; an image storing device storing a high payout image of the slot game; and a processor controlling the display, programmed to execute processes of: (a) judging whether a payout amount at the slot game has exceeded a predetermined amount or not; (b) if the payout amount at the slot game is judged to have exceeded the predetermined amount at the process (a), storing a notification image showing the payout amount at the slot game as the high payout image in the image storing device; and (c) displaying the high payout image read out from the image storing device on the display during a demonstration period.

Furthermore, according to another aspect, there is provided a slot machine, comprising: an input device with which a player executes a game operation; a slot game executed as a base game according to the game operation of the player with the input device; a bonus game executed following a unit game of the slot game according to a result of the unit game; a display displaying a series of gaming images from a start of the unit game of the slot game to an end of the bonus game; a first image storing device storing a temporary image; a second image storing device storing a high payout image; and a processor controlling the display, programmed to execute processes of: (a) storing the gaming images as the temporary image in the first image storing device; (b) judging whether a total payout amount at the gaming images has exceeded a predetermined amount; (c) if the total payout amount at the gaming images is judged to have exceeded the predetermined amount at the process (b), storing the temporary image in the first image storing device as the high payout image by overwriting in the second image storing device; (d) erasing the temporary image in the first image storing device; and (e) displaying the high payout image read out from the second image storing device on the display during a demonstration period.

### BRIEF DESCRIPTION OF THE DRAWINGS

FIG. 1 is a view showing characteristics of a slot machine according to one embodiment of the present invention;

FIG. 2 is a perspective view of the slot machine;

FIG. 3 is a schematic view showing symbol columns drawn on each of video reels;

FIG. 4 is a block diagram schematically showing an internal construction of entire slot machine;

FIG. 5 is a block diagram schematically showing an internal construction of a sub control board;

FIG. 6 is a payout table showing winning combinations and payout amounts thereof when a base game or a free game is conducted by using the video reels;

FIG. 7 is a view showing an image example displayed on a liquid crystal panel;

FIG. 8 is a view showing an image example displayed on the liquid crystal panel;

FIG. 9 is a flowchart of a main control program;

FIG. 10 is a flowchart of a main game process program;

FIG. 11 is a flow chart of a first high payout image process program;

FIG. 12 is a flow chart of a second high payout image process program;

FIG. 13 is a diagram showing a table in which high payout images and date-and-time images are associated with one another and recorded.

### DETAILED DESCRIPTION

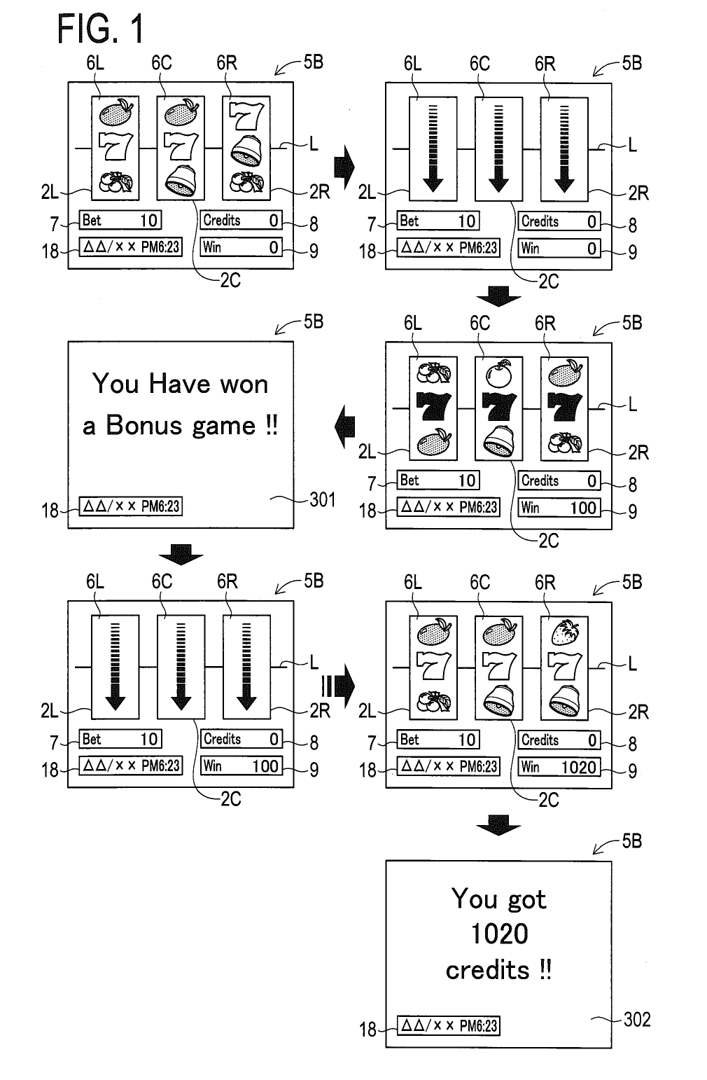

Hereinafter, the embodiment embodying the present invention is described with reference to the drawings. FIG. 1 is a view showing characteristics of a slot machine according to one embodiment of the present invention. When a liquid crystal panel 5B shown in FIG. 1 is specified, it is described by the No. of the stage from the uppermost stage of the figure.

A game conducted in the slot machine of the embodiment is constructed from two game modes of a base game and a bonus game.

In the base game, as shown in the picture on the left side in the first stage in FIG. 1, three symbols on each of three video reels 6L, 6C, 6R are arranged on each of three display windows 2L, 2C and 2R in the liquid crystal display panel 5B constructed from a well-known liquid crystal display panel. On the liquid crystal panel 5B, a pay line L, which crosses the three display windows 2L, 2C and 2R horizontally, is displayed. The pay line L is used to specify the combination of the symbols. Furthermore, a bet display portion 7, a credit amount display portion 8 and a payout amount display portion 9 are arranged on the liquid crystal panel 5B.

Also, each of various winning combinations is determined in advance based on the symbol combination of the symbols. As shown in the picture at the right side in the first stage and the picture at the right side in the second stage in FIG. 1, based on the rotation and stop of each video reel 6L, 6C and 6R, three symbols are rearranged within each display window 2L, 2C and 2R. Here, when the symbol combination constructed from the three symbols rearranged on the pay line L corresponds to any of the winning combinations, the payout amount corresponding to the winning combination is displayed on the payout amount display portion 9. Thereby, a unit game is formed. The payout amount displayed on the payout amount display portion 9 is added to the credit amount display portion 8 and is displayed, when a unit game is terminated. In other words, the base game is a so-called slot game.

When the symbol combination which is constructed from the three symbols rearranged on the pay line L, becomes a bonus game trigger, as shown in the picture at the right side in the second stage in FIG. 1, a predetermined payout amount is displayed on the payout amount display portion 9, and the game shifts to a free game which is one kind of the bonus games. In a free game, a unit game in a base game is repeated over a predetermined number of times. Here, the payout amount awarded in each of unit games is added and displayed in the payout amount display portion 9. And the predetermined number of times (for example, 20 times) is predetermined.

And when the game shifts to a free game, as shown in the picture at the left side in the second stage in FIG. 1, the title image of the free game is displayed first on the liquid crystal panel 5B.

Further, as in the liquid crystal panel 5B shown in the picture at the left side in the third stage in FIG. 1, each of the video reels 6L, 6C, and 6R start to rotate, so that a first unit game that constitutes a free game starts. Thereafter, by stopping/rotating/stopping respective video reels 6L, 6C and 6R being automatically repeated, unit games on each occasion that constitute the free game start/end. As such, as in the liquid crystal panel 5B shown in the picture at the right side in the third stage in FIG. 1, a unit game of final occasion that constitutes the free game ends.

When the unit game of the final occasion that constitutes the free game ends, as in the liquid crystal panel 5B shown in the picture at the right side in the third stage in FIG. 1, the payout amount display portion 9 displays total payout amount awarded in the unit game of the slot game and respective unit games of the free game to be executed following the unit game. Further, as in the liquid crystal panel 5B shown on the picture at the right side in the forth stage in FIG. 1, a notification image 302 showing total payout amount awarded in the unit game of the slot game and respective unit games of the free game executed following the unit game is displayed.

Further, the slot machine according to this embodiment stores gaming images of the liquid crystal panel 5B. Then, if total payout amount awarded in the unit game of the slot game and respective unit games of the free games executed following the unit game do not exceed the highest amount in the past, the gaming images of the liquid crystal panel 5B showing a series of the unit games are erased. Accordingly, if total payout amount awarded in the unit game of the slot game and respective unit games executed following the unit game exceed the highest amount in the past, the gaming images of the liquid crystal panel 5B showing the series of unit games are replayed in a subsequent demonstration period.

As in each liquid crystal panel 5B shown in FIG. 1, to the replayed images, an execution time display portion 18 that displays the date-and-time when a series of unit games were executed is composed.

Hereinafter, the embodiment embodying the present invention will be described in detail with reference to the drawings.

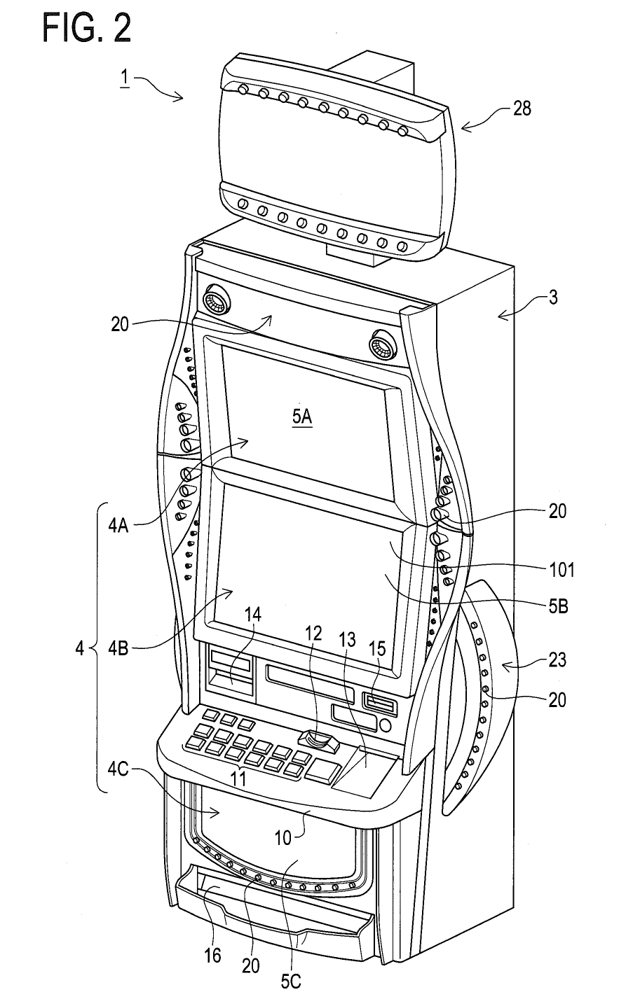

First, an outline construction of the slot machine 1 according to the embodiment is described with reference to FIG. 2. FIG. 2 is a perspective view of the slot machine 1 according to the embodiment.

As shown in FIG. 2, the slot machine 1 is an upright type gaming machine arranged in the game arcade such as casino, in order to execute predetermined game modes, such slot machine includes a cabinet 3 in which electronic and mechanical components are installed. For example, as a display portion 4 to display information concerning the game, there are provided an upper display portion 4A, a middle variable display portion 4B and a lower display portion 4C. Each display portion 4A to 4C is mounted at the front of the oblong cabinet 3. The upper display portion 4A includes a liquid crystal panel 5A which is arranged above the middle variable display portion 4B. On the liquid crystal panel 5A, for example, the effect image, the introduction of the game content, and the rule explanation of the game are displayed. The lower display portion 4C is arranged below the middle variable display portion 4B, and includes a plastic panel 5C on which the images are printed, and the plastic panel 5C is lightened by the backlights.

The middle variable display portion 4B, which is used to display the execution state of the game. On the liquid crystal panel 5B, the symbols of each video reel 6L, 6C, and 6R display in a rotating manner and in a stopped manner. In the middle variable display portion 4B, one pay line L horizontally crossing each of areas corresponding to the video reels 6L, 6C, and 6R is displayed on the liquid crystal display panel 5B. Also, in front of the liquid crystal panel 5B, a touch panel 101 is arranged, and a player may input his/her various instructions by operating the touch panel 101. As not shown in FIG. 2, on the lower position of the middle variable display portion 4B, the bet display portion 7, the credit amount display portion 8 and the payout amount display portion 9 are arranged on the liquid crystal panel 5B. Also the upper portion of the middle variable display portion 4B, is related to the back side, thereby a player may play games in a cozy posture.

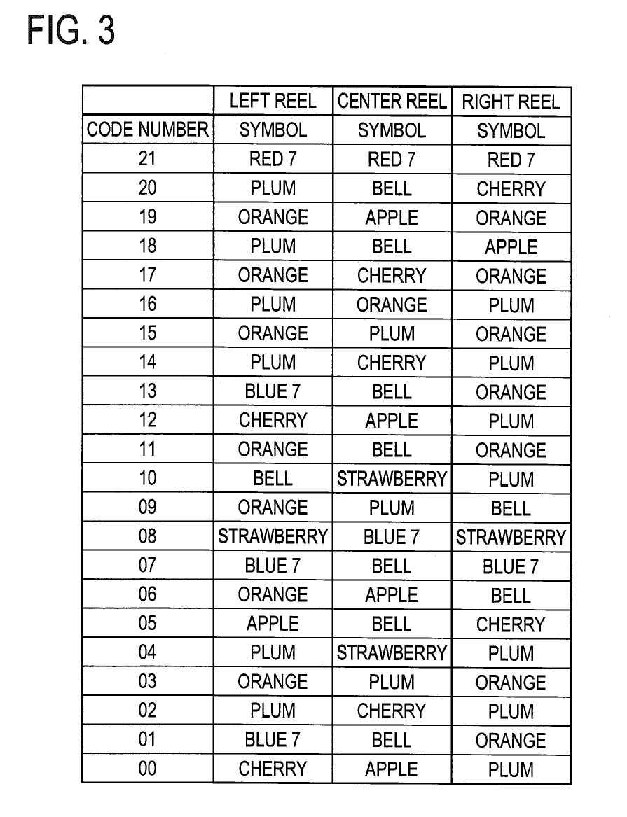

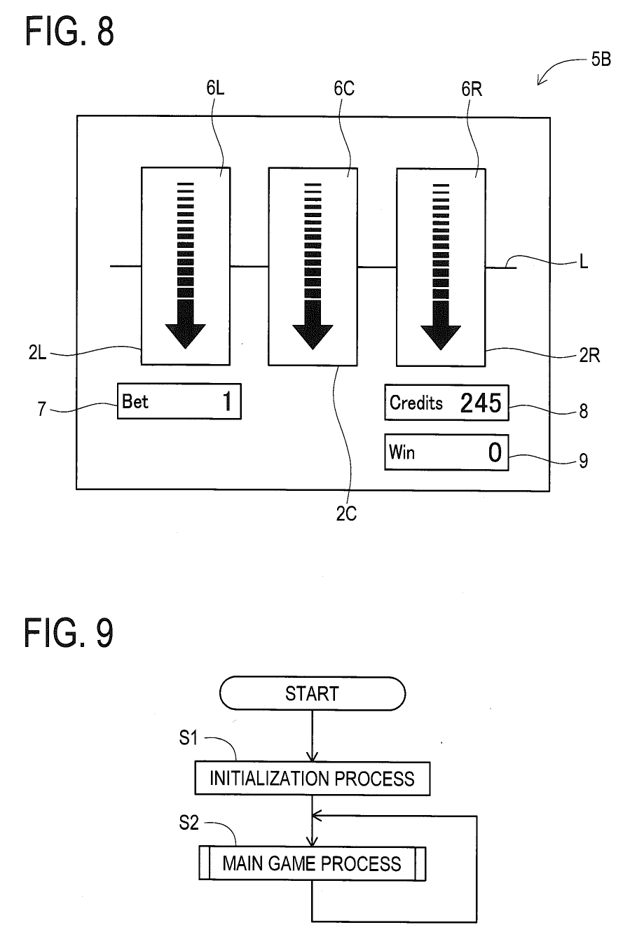

Here, the image of the gaming displayed on the liquid crystal panel 5B will be explained. FIG. 7 and FIG. 8 are the figures showing the contents displayed on the liquid crystal panel 5B. On each display window 2L, 2C and 2R of the liquid crystal panel 5B, during a base game and a free game, as shown in FIG. 7 and FIG. 8, the symbols drawn on the reel band of each video reel 6L, 6C, and 6R are displayed to be visible to a player. FIG. 7 shows the arranged or rearranged state of the symbols which are drawn on the reel band of each video reel 6L, 6C, and 6R, on each display window 2L, 2C and 2R of the liquid crystal panel 5B. FIG. 8 shows the rotating state of the symbols which are drawn on the reel band of each video reel 6L, 6C, and 6R, on each display window 2L, 2C and 2R. On the reel band of each video reel 6L, 6C, and 6R, a symbol column constructed from twenty-two symbols is displayed respectively (refer to FIG. 3).

On the liquid crystal panel 5B, the bet display portion 7, the credit amount display portion 8 and the payout amount display portion 9 are arranged. On the bet display portion 7, the bet number betted in a base game (a unit game of a slot game) by a player is displayed. On the payout amount display portion 9, the payout amount awarded in a base game (a slot game) or in a free game by a player is displayed. On the credit amount display portion 8, the credit amount which is owned by a current player is displayed.

Therefore, on the three display windows 2L, 2C and 2R of the liquid crystal panel 5B during a base game and a free game, three symbols which are drawn on the reel band of each video reel 6L, 6C, and 6R are arranged. On the liquid crystal panel 5B during a base game and a free game, as shown in FIG. 7 and FIG. 8, the pay line L crossing the three display windows 2L, 2C and 2R horizontally is displayed. The pay line L is used to specify the symbol combination.

Returning to FIG. 2, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a CASHOUT button, are arranged as the operation portion to execute the game. On the operation table 10, a coin insertion slot 12 and a bill insertion slot 13 are arranged. Also between the operation table 10 and the middle variable display portion 4B, a ticket printer 14 and a card reader 15 are arranged. At the lowest position of the cabinet 3, a coin tray 16 is also arranged.

In the slot machine 1 of the embodiment, the gaming medium may be coin, bill, or electronic value (credit). Here, the gaming medium may be others as well, such as medal, token, electronic money, or ticket.

On the cabinet 3 of the slot machine 1, light emitting portions 20 are arranged around the game area including the upper display portion 4A, the middle variable display portion 4B, the lower display portion 4C and the operation table 10.

The slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

Next, the symbols drawn on the reel band of each video reel 6L, 6C, and 6R will be explained with reference to FIG. 3. These symbols are scrolled and rearranged on each display window 2L, 2C and 2R of the liquid crystal panel 5B during a base game and a free game. FIG. 3 is a schematic view schematically showing symbol columns drawn on the reel band of each video reel 6L, 6C, and 6R.

On the reel band of each video reel 6L, 6C, and 6R, twenty-two symbols are arranged respectively. Each symbol column is constructed from the symbols including [RED 7], [BLUE 7], [BELL], [APPLE], [CHERRY], [STRAWBERRY], [PLUM] and [ORANGE]. And the symbols of the predetermined types are arranged in a predetermined sequence.

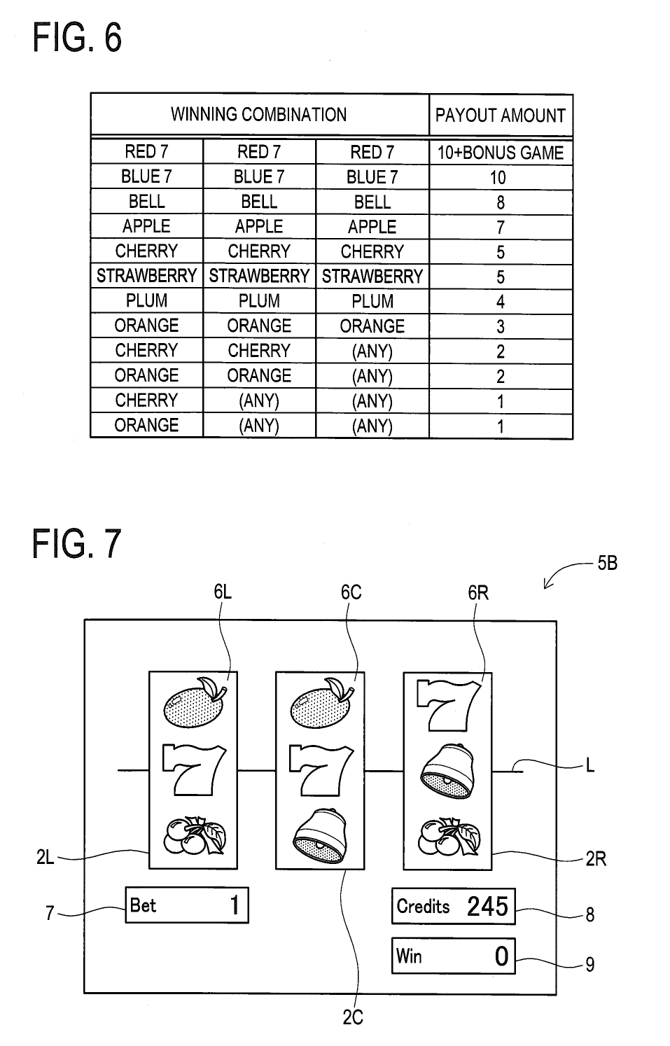

Here, when three symbols of [BLUE 7], [BELL], [APPLE], [CHERRY], [STRAWBERRY], [PLUM] and [ORANGE] are rearranged on the pay line L of the liquid crystal panel 5B, a predetermined payout amount is awarded to a player (refer to FIG. 6). Also, regarding the symbols of [CHERRY] and [ORANGE], even when one or two [CHERRY] or [ORANGE] is/are rearranged on the pay line L of the liquid crystal panel 5B, a predetermined payout amount corresponding to the number of the symbols is awarded to a player (refer to FIG. 6).

When three symbols of [RED 7] are rearranged on the pay line L of the liquid crystal panel 5B, a predetermined payout amount is awarded to a player, and also the game shifts from a base game to a free game.

To each symbol consisting each symbol column shown in FIG. 3, a symbol number is allocated from top to down in sequence.

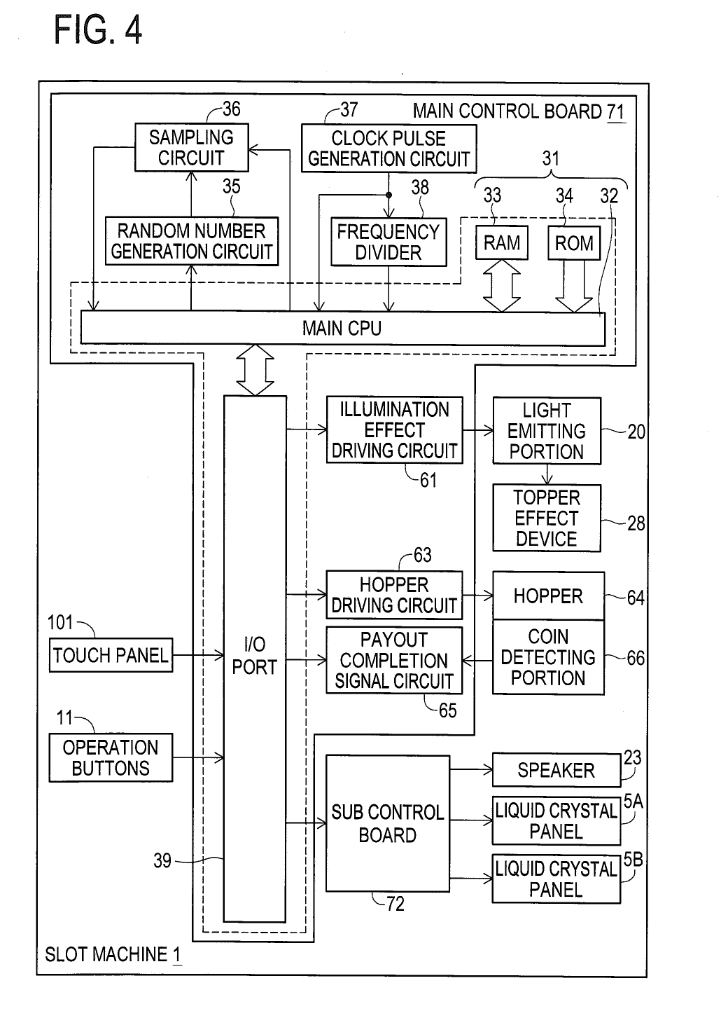

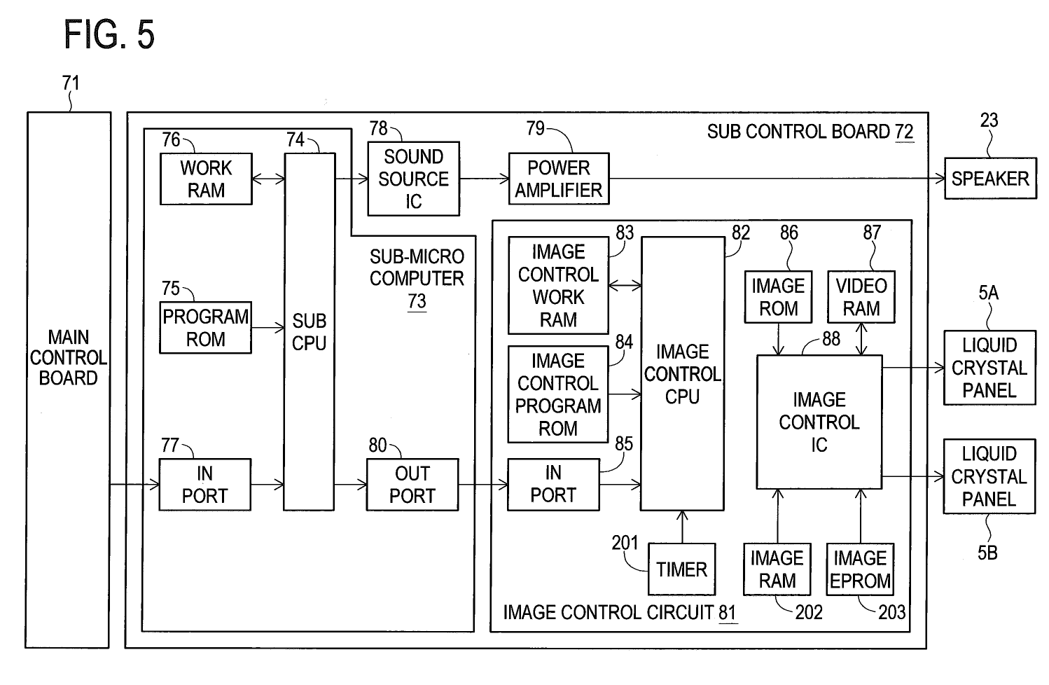

Next, the internal construction of the above slot machine 1 will be explained with reference to FIG. 4 and FIG. 5.

FIG. 4 is a block diagram schematically showing the internal construction of entire slot machine 1. As shown in FIG. 4, the slot machine 1 includes a plurality of construction elements such as a main control board 71, in which a microcomputer 31 is included. The main control board 71 is constructed from a microcomputer 31, a random number generation circuit 35, a sampling circuit 36, a clock pulse generation circuit 37 and a frequency divider 38. The main control board 71 also includes an illumination effect driving circuit 61, a hopper driving circuit 63 and a payout completion signal circuit 65.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire slot machine 1. Data and programs used when the main CPU 32 runs are stored in the RAM 33. For example, random numbers which are sampled by the after-mentioned sampling circuit 36 are stored temporarily after the start of the game, also the code number of each video reel 6L, 6C, and 6R and the symbol numbers are stored in the RAM 33. And the programs executed by the main CPU 32 and the permanent data are stored in the ROM 34.

Especially, the programs stored in the ROM 34 include the game programs and the game system programs (abbreviated as “the game programs and the like” hereinafter). And a lottery program mentioned below is also included in the game programs.

The lottery program is a program used to determine the code number of each video reel 6L, 6C, and 6R which corresponds to each symbol rearranged on the pay line L of the liquid crystal panel 5B. In the lottery program, it is included symbol weighing data corresponding to each of plural kinds of payout rates (for example, 80%, 84% and 88%). The symbol weighing data are the data indicating correlation between the code number of each video reel and one or plural random numbers belonging to a predetermined number range (0 to 255), every each of the three video reels 6L, 6C, and 6R. In other words, each of the code number of one video reel is associated with one or more random numbers corresponding to the payout rate. The random number is extracted by the lottery program, and the symbol specified finally by the random number is rearranged on the pay line L of the liquid crystal panel 5B.

Random numbers over a predetermined range are generated by the random number generation circuit 35, which is operated based on the instructions from the main CPU 32. The random numbers are voluntarily extracted from the random numbers generated by the random number generation circuit 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38.

And the touch panel 101 is connected to the main control board 71. The touch panel 101 is arranged in front of the liquid crystal panel 5B, and specifies the coordinate position of the portion touched by a player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include a spin button, a collecting button and a BET button and the like. The signals corresponding to the pressing of these buttons are input to the main CPU 32 through I/O port 39.

The effect signals which are used to conduct illumination effect are output to the above-mentioned light emitting portion 20 and the topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65.

Furthermore, a sub control board 72 is connected to the main control board 71. As shown in FIG. 5, commands from the main control board 71 are input to the sub control board 72. The display control on the liquid crystal panel 5A of the upper display portion 4A and the liquid crystal panel 5B of the variable display portion 4B, and the sound output control on the speaker 23 is executed by the sub control board 72. The sub control board 72 is constructed on a circuit board different from the circuit board for the main control board 71, and includes a microcomputer 73 (abbreviated as “sub-microcomputer” hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub CPU 74, a program ROM 75, a work RAM 76, an IN port 77 and an OUT port 80. The control operations are executed by sub CPU 74 based on the control order transmitted from the main control board 71, the program ROM 75 is used as a memory device. Although a clock pulse generation circuit, a frequency divider, a random number generation circuit and a sampling circuit are not included in the sub control board 72, the sub control board 72 is constructed so as to execute random number sampling according to the operation programs thereof. The control programs executed by the sub CPU 74 are stored in the program ROM 75. The work RAM 76 is constructed as a temporary storing means when the above control programs are executed by the sub CPU 74.

The image control circuit 81 includes an image control CPU 82, an image control work RAM 83, an image control program ROM 84, an IN port 85, an image ROM 86, a video RAM 87, an image control IC 88, a timer 201, an image RAM 202 and an image EPROM 203. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing means when the image control programs are executed by image control CPU 82. Images corresponding to the content determined by the image control CPU 82 are formed by the image control IC 88, and are output to the liquid crystal panel 5A, 5B.

The image ROM 86 stores dot data for forming images. Thus, it stores the dot data on symbols drawn on the reel band of the each video reel 6L, 6C and 6R or the dot data on demonstration images. The video RAM 87 runs as a temporary storing means when the images are formed by the image control IC 88. The timer 201 times the passage of time including year and month, and inputs a signal thereof into the image control CPU 82. The image RAM 202 is configured as a means for temporarily storing images outputted to the liquid crystal panel 5B. The image EPROM 203 stores images temporarily stored in the image RAM 202.

Further, the image control circuit 81 performs display control of the rotation display/stop display of the video reels 6L, 6C, and 6R on the respective display windows 2L, 2C and 2R of the liquid crystal panel 5B, based on control signals from the main CPU 32. Furthermore, the image control circuit 81 also performs display control on the bet display portion 7, the credit amount display portion 8, or the payout amount display portion 9, based on control signals from the main CPU 32.

Next, winning combinations and the payout amounts corresponding to the winning combinations will be explained with reference to FIG. 6, wherein the winning combinations are the symbol combinations when a base game or a free game is executed by using each of the video reels 6L, 6C, and 6R in the slot machine 1 according to the embodiment. FIG. 6 is a payout table in which the winning combinations and the payout amounts corresponding to the winning combinations are shown when a base game or a free game is executed by using each of the video reels 6L, 6C, and 6R.

Here, the payout amount shown in FIG. 6 indicates the payout amount when the bet number is “1” in a base game and a free game. Therefore, when the bet number is “1”, the payout amount shown in FIG. 6 is paid out, and when the bet number is more than “2”, the payout amount obtained by multiplying the payout amount shown in FIG. 6 with the bet number is paid out.

Thereby, when three symbols of [RED 7] are rearranged on the pay line L of the liquid crystal panel 5B, the payout amount obtained by multiplying 10 credits with the bet number is paid out. And in a base game, when the bonus trigger is realized, a free game is generated. Also, in a free game, the bonus trigger may be realized, at that time, a new free game is generated.

When three symbols of [BLUE 7] are rearranged on the pay line L of the liquid crystal panel 5B, the payout amount obtained by multiplying 10 credits with the bet number is paid out.

When three symbols of [BELL] are rearranged on the pay line L of the liquid crystal panel 5B, the payout amount obtained by multiplying 8 credits with the bet number or the predetermined magnification is paid out.

The payout amount corresponding to each winning combination shown in FIG. 6, are set as the same in the above. However, when a symbol combination constructed from the symbols rearranged on the pay line L of the liquid crystal panel 5B, is not any of the winning combinations shown in FIG. 6, the symbol combination is not a winning combination. Therefore, no credits may be paid out.

As mentioned above, in the slot machine 1 according to the embodiment, a slot game is executed as a base game, and a free game is executed as the bonus game respectively.

In other words, in a base game, a slot game is executed by rearranging a specific symbol combination on the pay line L of the liquid crystal panel 5B by each video reel 6L, 6C, and 6R. In the slot game, firstly, a part of symbol column (three symbols) drawn on the reel band of each video reel 6L, 6C, and 6R (shown in FIG. 3), is arranged on each display windows 2L, 2C and 2R of the liquid crystal panel 5B (refer to FIG. 7). Here, after a player sets the bet number by pressing the BET button among the operation buttons 11, if the player presses the spin button, each of the video reels 6L, 6C, and 6R rotates, the symbol column drawn on the reel band of each video reel 6L, 6C, and 6R shown in FIG. 3, is scrolled from up to down and displayed on each of the display windows 2L, 2C and 2R of the liquid crystal panel 5B (refer to FIG. 8).

After a predetermined time, each video reel 6L, 6C, and 6R stops automatically, a part of the symbol column (three symbols) displayed on the reel band of each video reel 6L, 6C, and 6R (shown in FIG. 3), is arranged on each display window 2L, 2C and 2R of the liquid crystal panel 5B (refer to FIG. 7). On the other hand, each winning combination based on each symbol combination is determined beforehand (refer to FIG. 6). When the symbol combination constructed from the three symbols rearranged on the pay line L of the liquid crystal panel 5B, realizes a winning combination, the payout amount obtained by multiplying the bet number with the payout amount corresponding to the realized winning combination is awarded to the player.

On the other hand, in a free game as the bonus game, the slot game, in which a specific symbol combination is rearranged on the pay line L of the liquid crystal panel 5B by each video reel 6L, 6C, and 6R, is repeated over the predetermined number of times. Also, in the slot game, a part of the symbol column (three symbols) drawn on the reel band of each video reel 6L, 6C, and 6R as shown in FIG. 3, is arranged on each display window 2L, 2C and 2R of the liquid crystal panel 5B (refer to FIG. 7). However, here, after a predetermined time, each video reel 6L, 6C, and 6R rotates automatically. Thereby, no matter whether the player presses the operation buttons 11 such as the BET button or the spin button, the symbol column drawn on the reel band of each video reel 6L, 6C, and 6R as shown in FIG. 3, is scrolled from up to down and displayed on each display window 2L, 2C and 2R of the liquid crystal panel 5B (refer to FIG. 8).

Furthermore, after a predetermined time, each video reel 6L, 6C, and 6R stops automatically, a part of the symbol column (three symbols) drawn on the reel band of each video reel 6L, 6C, and 6R as shown in FIG. 3, is rearranged on each display window 2L, 2C and 2R of the liquid crystal panel 5B (refer to FIG. 7). On the other hand, similar to the above base game, each kind of winning combination is determined beforehand based on the symbol combination (refer to FIG. 6). When the symbol combination, which is constructed from the three symbols rearranged on the pay line L of the liquid crystal panel 5B, is a winning combination, the payout amount obtained by multiplying the payout amount corresponding to the realized winning combination with the bet number is awarded to the player.

The predetermined number of times for a free game (for example, 20 times) is set in advance.

Next, a main control program executed in the slot machine 1 according to the embodiment will be explained with reference to figures. FIG. 9 is a flowchart of the main control program.

First, when the power switch is pressed, the microcomputer 31 is started to operate, an initialization is executed by the microcomputer 31 in step (abbreviated as “S”) 1. In an initialization process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initialization process, the verification process to each program is executed by the main CPU 32.

And in S2, the main CPU 32 reads out the game programs and the like from the RAM 33, and executes the programs in sequence so as to conduct a main game process. The game is executed in the slot machine 1 according to the embodiment by executing the main game process. And the main game process is repeated when the power is supplied to the slot machine 1.

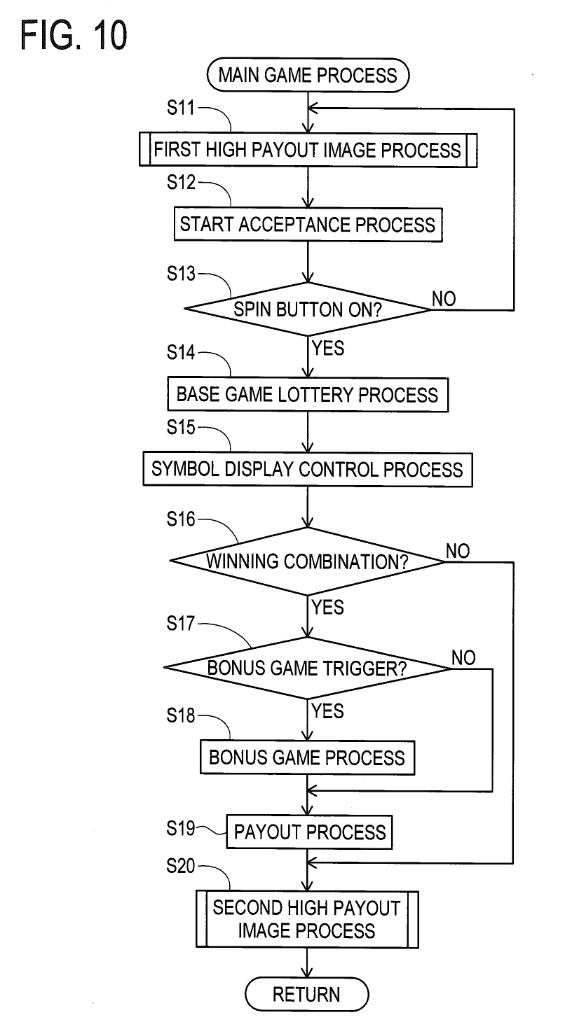

Next, the sub process of the main game process in S2 will be explained with reference to FIG. 10. FIG. 10 is a flowchart of a main game process program in the slot machine 1 according to the embodiment. Also, each program shown in the flowchart of FIG. 10 is stored in the ROM 34 or the RAM 33 of the slot machine 1, and is executed by the main CPU 32.

First, as shown in FIG. 10, the main CPU 32 executes a first high payout image process in S11. Details of the first high payout image process are described later. Then, in S12, the main CPU 32 executes a start acceptance process. Then, in the start acceptance process, a player performs coin insertion or bet operation using the operation buttons 11 of the BET button. Further, the bet number set based on the above bet operation is reduced from the credits owned by the player at that time, and is stored in the RAM 33 as the bet information. And the credit count after reduction is also stored in the RAM 33 as the bet information. Additionally, the credit amount after the deduction is stored as credit information in the RAM 33. Then, by transmitting control signals to the sub control board 72, the main CPU 32 displays not only the bet information stored in the RAM 33 on the bet display portion 7 of the liquid crystal panel 5B, but also the credit information stored in the RAM 33 (the credit amounts after the deduction described above) on the credit amount display portion 8 of the liquid crystal panel 5B.

And then, it is determined by the main CPU 32 whether the spin button among the operation buttons 11 is pressed in S13. It is determined based on the input signals corresponding to the button pressing of the operation button 11 to the main CPU 32. Here, when the spin button among the operation buttons 11 is not pressed (S13: NO), the game returns to the first high payout image process (S11) again. Thereby, it is possible to change the bet number and the like in S2, hereafter. On the other hand, when the spin button among the operation buttons 11 is pressed (S13: YES), the bet number set based on the above bet operation is reduced from the credits owned by the player at that time, and is stored in the RAM 33 as the bet information. And the credit count after reduction is also stored in the RAM 33 as the bet information. Then, by transmitting control signals to the sub control board 72, the main CPU 32 displays not only the bet information stored in the RAM 33 on the bet display portion 7 of the liquid crystal panel 5B, but also the credit information stored in the RAM 33 (the credit amounts after the deduction described above) on the credit amount display portion 8 of the liquid crystal panel 5B.

In S14, a base game lottery process is executed by the main CPU 32. Concretely, when the base game lottery program included in the game programs is executed by the main CPU 32, the random number corresponding to each video reel 6L, 6C, and 6R respectively is selected from a range of 0 to 255. And with reference to the symbol weighing data corresponding to the payout rate setting data, based on the three random numbers, the code number of each video reel 6L, 6C, and 6R is determined. The determined code number of each video reel 6L, 6C, and 6R is stored in the RAM 33 by the main CPU 32, and the game proceeds to S15.

Here, because the code number of each video reel 6L, 6C, and 6R, corresponds to the symbol numbers (symbol numbers in FIG. 3) which is rearranged on the pay line L of the liquid crystal panel 5B, based on the determination of the code number of each video reel 6L, 6C, and 6R by the main CPU 32, the symbol combination in the game is determined. For example, when the code number of each video reel 6L, 6C, and 6R is determined as “21”, “21” and “21”, it is determined that the symbol combination is constructed from the three symbols of [RED 7] by the main CPU 32 (refer to FIG. 3). Therefore, the lottery of the symbol combination in a base game is conducted based on the determination of the code number of each video reel 6L, 6C, and 6R.

When the game proceeds to S15, a symbol display control process is executed by the main CPU 32. Concretely, first, a reel rotation process is executed by the main CPU 32. In other words, control signals are transmitted to the sub control board 72 by the main CPU 32, so as to display each video reel 6L, 6C, and 6R in a rotating manner. And then, the effect mode (the display mode of the images on the liquid crystal panel 5B and the sound output mode from the speaker 23) is determined by the main CPU 32, and the sub control board 72 is ordered to start the effect in a predetermined effect pattern. And then, when the predetermined stop timing to display each video reel 6L, 6C, and 6R in a rotating manner comes, a reel stop process is executed by the main CPU 32 which transmits control signals to the sub control board 72. Thereby each video reel 6L, 6C, and 6R is displayed in a stopping manner, based on the code numbers stored in the RAM 33. Thereby, the symbol combination determined in above S14 is rearranged on pay line L of the liquid crystal panel 5B.

And in the S16, it is determined by the main CPU 32 whether a winning combination is realized. The determination is made based on the code number of each video reel 6L, 6C, and 6R stored in the RAM 33. Here, when a winning combination is not realized (S16: NO), the game proceeds to S20 described later. On the other hand, when a winning combination is realized (S16: YES), the game proceeds to S17.

In the S16, a payout amount display process is executed by the main CPU 32. Concretely, first, the payout amount obtained by multiplying the payout amount corresponding to the winning combination rearranged on the pay line L of the liquid crystal panel 5B with the bet number is calculated. And the calculation is executed based on the bet information in the RAM 33 and the payout table of FIG. 6, and the calculated amount is stored in RAM 33 as the payout information. And then, control signals are transmitted to the sub control board 72 by the main CPU 32, the payout information stored in the RAM 33 (the above calculated amount) is displayed on the payout amount display portion 9 of the liquid crystal panel 5B.

And when the game proceeds to S17, it is determined whether a bonus game trigger is realized by the main CPU 32. Concretely, when the three symbols of [RED 7] are rearranged on the pay line L of the liquid crystal panel 5B, it is determined that the bonus game trigger is realized. And this determination is executed based on the code number of each video reel 6L, 6C, and 6R stored in the RAM 33. Here, when a bonus game trigger is realized (S17: YES), control signals are transmitted to the sub control board 72 by the main CPU 32, the title image of the free game is displayed on the liquid crystal panel 5B (refer to the right side of the second stage in FIG. 1). And then in S18, a bonus game process is executed. Additionally, the slot game that is the base game is automatically repeated up to the predetermined number of times in the bonus game process, and details thereof are omitted.

Next, in S19, a payout process is executed, including the case when a bonus game trigger is not realized (S17: NO). In the payout process, the payout amount awarded to the player in the base game and the free game is paid out to the player respectively, based on the payout information stored in the RAM 33.

When the payout is executed, the credits which are stored in the RAM 33 as the payout information (the payout amount was awarded to the player in the base game and the free game respectively) are added to the credits stored in the RAM 33 as the credit information, and the added value is overwritten in the RAM 33 as the credit information. And then, control signals are transmitted to the sub control board 72 by the main CPU 32, the credits information stored in the RAM 33 (the added value in S19) is displayed on the credit amount display portion 8 of the liquid crystal panel 5B. At the same time, “0” is overwritten to the RAM 33 as the payout information, and by transmitting control signals to the sub control board 72, on the payout amount display portion 9 of the liquid crystal panel 5B, “0” is displayed.

In the payout process, the credits owned by the player at that time (1 credit equals to 1 coin) may be paid out by the coins corresponding to based on the pressing on the CASHOUT button among the operation buttons 11, or may also be paid out by a ticket with a bar code which is printed by the ticket printer 14.

And the main game process is executed again, via S20 of the second high payout image process described later, after the payout process in above S19 is executed by the main CPU 32.

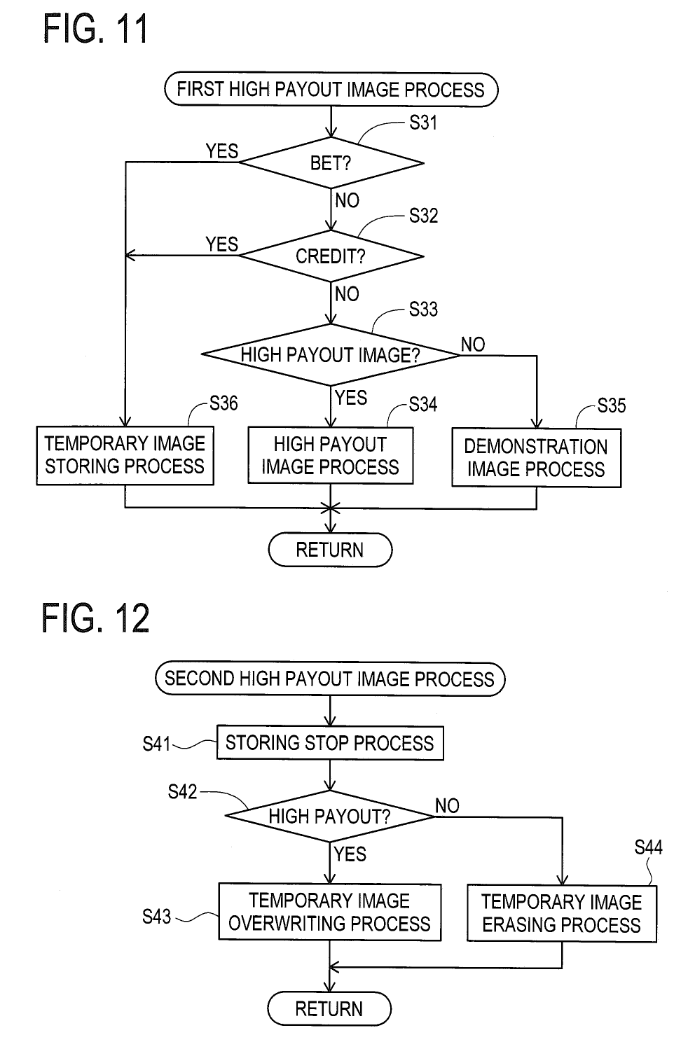

In the following, based on FIG. 11, a description is made on sub processes of the first high payout image process of S11 described above. FIG. 11 is a flow chart of the first high payout image process program in the slot machine 1 according to this embodiment. Additionally, respective programs shown below in the flowchart in FIG. 11 are stored in the ROM 34 or the RAM 33 of the slot machine 1, and executed by the main CPU 32.

First, as shown in FIG. 11, in S31, the main CPU 32 determines whether or not a bet number is set. This determination is made based on the bet information stored in the RAM 33. Now, if a bet number is set (S31: YES), the game proceeds to S36 described later. Alternatively, if a bet number is not set (S31: NO), the game proceeds to S32.

In S32, the main CPU 32 determines whether or not there is any credit amount. This determination is made based on the credit information stored in the RAM 33. Now, if there is any credit amount (S32: YES), the game proceeds to S36 described later. Alternatively, if there is no credit amount (S32: NO), the game proceeds to S33.

In S33, the main CPU 32 determines whether or not there is a high payout image. This determination is made based on the high payout image information stored in the RAM 33. Additionally, the high payout image information is generated in the second high payout image process in S20 of FIG. 10, to be described later. Now, if there is a high payout image (S33: YES), the game proceeds to S34.

In S34, the main CPU 32 executes a high payout image process. In this high payout image process, the main CPU 32 displays the high payout image stored in the image EPROM 203 on the liquid crystal panel 5B, by transmitting control signals to the sub control board 72. Then, it returns to the main game process of FIG. 10 above. Additionally, the high payout image is generated in the second high payout image process in S20 of FIG. 10, to be described later.

Alternatively, if there is no high payout image (S33: NO), the game proceeds to S35. In S35, the main CPU 32 executes a demonstration image process. In this demonstration image process, the main CPU 32 displays a demonstration image on the liquid crystal panel 5B, by transmitting control signals to the sub control board 72. Then, it returns to the main game process of FIG. 10 above.

Further, if a bet number is set (S31: YES) or if there is any credit amount (S32: YES), the game proceeds to S36 as described above. In S36, the main CPU 32 executes a temporary image storing process. In this temporary image storing process, by transmitting control signals to the sub control board 72, the main CPU 32 starts/maintains causing the image RAM 202 to store a temporary image that a date-and-time image is composed to gaming images. Then, it returns to the main game process of FIG. 10 above.

The gaming images herein refer to images of games in the base game or the free game, which are displayed on the liquid crystal panel 5B, wherein images start from a bet operation on a unit game of a slot game that is a base game. The date-and-time image refers to an image on which the date-and-time when the bet operation is performed in the gaming image is displayed, and, a specific example is the execution time display portion 18 of each liquid crystal panel 5B in FIG. 1 above. Additionally, the date-and-time is obtained from the timer 201 by the sub control board 72 having received control signals from the main CPU 32.

In the following, based on FIG. 12, a description is made on sub processes of the second high payout image process in S20 of FIG. 10 above. FIG. 12 is a flow chart of the second high payout image process program in the slot machine 1 according to this embodiment. Additionally, respective programs shown below in the flowchart in FIG. 12 are stored in the ROM 34 or RAM 33 of the slot machine 1, and executed by the main CPU 32.

First, as shown in FIG. 12, the main CPU 32 executes a storing stop process in S41. In this storing stop process, by transmitting control signals to the sub control board 72, the main CPU 32 stops storing temporary images in the image RAM 202 that was started/maintained in S36 described above. In this respect, the temporary images stored in the image RAM 202 are images as displayed on each liquid crystal panels 5B in FIG. 1 above. Then, the game proceeds to S42.

In S42, the main CPU 32 determines whether payout is high or not. In this determination, if the credit amount of the payout information stored in the RAM 33 (the payout amount the player was awarded in a base game or a free game) exceeds the highest amount, it is considered high payout. Now, if the payout is high (S42: YES), the game proceeds to S43.

However, as the highest amount is stored as highest amount information in the RAM 33, and when proceeding to S43, the main CPU 32 updates the highest amount information in the RAM 33 to the credit amount of the payout information currently stored in the RAM 33.

In S43, the main CPU 32 executes a temporary image overwriting process. In this temporary image overwriting process, by transmitting control signals to the sub control board 72, the main CPU 32 retrieves the temporary image stored in the image RAM 202, and overwrites the image EPROM 203 with the retrieved temporary image as the high payout information. Further, the main CPU 32 stores information that there is a high payout image in the RAM 33 as the high payout image information. Then, it returns to the main game process of FIG. 10 above.

Alternatively, if the payout is not high (S42: NO), the game proceeds to S44. In S44, the main CPU 32 erases the temporary image stored in the image RAM 202, by transmitting control signals to the sub control board 72. Then, it returns to the main game process of FIG. 10 above.

As described in detail above, in the slot machine 1 according to this embodiment, gaming images of a unit game of a slot game in which the highest payout amount in the past was awarded, or gaming images of a unit game of a slot game in which the highest payout amount in the past was awarded and respective unit games of free games executed following the unit game are replayed on the liquid crystal panel 5B in a demonstration period (S34, refer to FIG. 1). Therefore, it is possible to make players feel that realization of earning of the highest amount of the payout that was realized in the past is within reach.

Nevertheless, when the game starts, it is unknown whether or not a player will be awarded a payout amount higher than the highest payout amount in the past. Thus, the image RAM 202 starts to temporarily store gaming images of a unit game of a slot game and respective unit games of free games executed following the unit game, from the time point when a bet operation on the unit game of that slot game has was performed (S36). Then, if the payout amount that has been the highest so far is awarded, the gaming images thereof are transferred from the image RAM 202, overwriting the image EPROM 203 (S43). Alternatively, if the payout amount that has been the highest so far is not awarded, the gaming images thereof are erased from the image RAM 202 (S44). Thus, it becomes possible to handle gaming images of a large amount of data in the configuration in which the storing devices such as the image RAM 202 or the image EPROM 203 have the saved memory capacity.

Further, the slot machine 1 according to this embodiment can provide players with materials based on which players subjectively estimate the time when obtaining of high payout will be realized in the future, because the execution time display portion 18 which displays the date-and-time of performing of a bet operation is composed to gaming images replayed on the liquid crystal panel during a demonstration period (S36, refer to FIG. 1).

Additionally, the present invention is not limited to the embodiments described above, but various changes may be made without departing from its scope.

For example, in the slot machine 1 according to this embodiment, in the determination in S42, the main CPU 32 considers the case in which the credit amount of payout information stored in the RAM 33 (payout amount the player was awarded in a base game or a free game) exceeds a predetermined amount as high payout. Further, in the temporary image overwriting process in S43, the main CPU 32 retrieves the temporary image stored in the image RAM 202, adds the retrieved temporary image, as a high payout image, to the image EPROM 203, and stores it. Then, in the high payout image process in S34, if more than one high payout images are stored in the image EPROM 203, the main CPU 32 sequentially displays the respective high payout images stored in the image EPROM 203 on the liquid crystal panel 5B, with the order specified by the magnitude of payout amount.

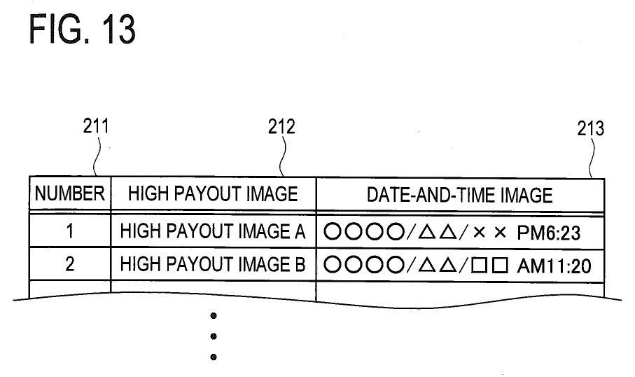

FIG. 13 shows one example of a memory table of the image EPROM 203 in this case. In the memory table shown in FIG. 13, a record 211 stores numeric values showing the order of the magnitude of payout amount, a record 212 stores high payout images, and a record 213 stores data which added data of the date-and-time that is the date-and-time image composed to the high payout images to the western calendar. Additionally, each data stored in the record 213 is utilized when more than one high payout images stored in the image EPROM 203 are sequentially displayed on the liquid crystal panel 5B with the order specified by anything other than the magnitude of payout amounts.

Alternatively, in the slot machine 1 according to this embodiment, in the temporary image storing process in S36, the main CPU 32 may handle, as gaming images, only the notification image 302 (refer to the right side of the fourth stage in FIG. 1) showing the total payout amount awarded in the unit game of the slot game and the respective unit games of the free games executed following the unit game. In this case, the main CPU 32 handles images of the execution time display portion 18 which displays the date-and-time when the notification image 302 was displayed on the liquid crystal display 5 as date-and-time images.

Even in these cases, it is possible to make players feel that realization of obtaining of the highest or high amount payout realized in the past is within reach, and to provide them with any material based on which the players subjectively estimate the time when obtaining of high payout will be realized in the future.

What is claimed is:

1. A slot machine comprising:
an input device with which a player executes a game operation;
a display on which an image of a slot game is displayed based on the game operation of the player with the input device;
an image storing device storing a high payout image of the slot game; and
a processor controlling the display, programmed to execute processes of:
(a) judging whether a payout amount at the slot game has exceeded a predetermined amount or not;
(b) if the payout amount at the slot game is judged to have exceeded the predetermined amount at the process (a), storing a notification image showing the payout amount at the slot game as the high payout image in the image storing device; and
(c) displaying the high payout image read out from the image storing device on the display during a demonstration period.

2. The slot machine of claim 1, further comprising:
a payout amount storing device storing a payout amount at the slot game, wherein the processor is programmed, when executing the process (a), to execute processes of:
(1) storing a payout amount at the slot game in the payout amount storing device; and
(2) if the payout amount at the slot game is a highest of all payout amounts stored in the payout amount storing device, judging the payout amount at the slot game to have exceeded the predetermined amount.

3. The slot machine of claim 1, further comprising:
a timing system timing a date-and-time when the notification image of the slot game is displayed on the display, wherein
the processor is programmed, when executing the process (b), to execute processes of:
(1) generating a date-and-time image showing the date-and-time timed by the timing system; and
(2) storing the date-and-time image generated at the process (1) in the image storing device as part of the high payout image.

4. A slot machine comprising:
an input device with which a player executes a game operation;
a slot game executed as a base game according to the game operation of the player with the input device;
a bonus game executed following a unit game of the slot game according to a result of the unit game;
a display displaying a series of gaming images from a start of the unit game of the slot game to an end of the bonus game;
a first image storing device storing a temporary image;
a second image storing device storing a high payout image; and
a processor controlling the display, programmed to execute processes of:
(a) storing the gaming images as the temporary image in the first image storing device;
(b) judging whether a total payout amount at the gaming images has exceeded a predetermined amount;
(c) if the total payout amount at the gaming images is judged to have exceeded the predetermined amount at the process (b), storing the temporary image in the first image storing device as the high payout image by overwriting in the second image storing device;
(d) erasing the temporary image in the first image storing device; and
(e) displaying the high payout image read out from the second image storing device on the display during a demonstration period.

5. The slot machine of claim 4, further comprising:
a payout amount storing device storing the total payout amount at the gaming images, wherein the processor is programmed, when executing the process (b), to execute processes of:
(1) storing the total payout amount at the gaming images in the payout amount storing device; and
(2) if the total payout amount at the gaming images is a highest of all total payout amounts stored in the payout amount storing device, the total payout amount at the gaming images is judged to have exceeded the predetermined amount.

6. The slot machine of claim 4, further comprising:
a timing system timing a date-and-time when the gaming images are displayed on the display, wherein
the processor is programmed, when executing the process (a), to execute processes of:
(1) generating a date-and-time image showing the date-and-time timed by the timing system; and
(2) storing the date-and-time image generated at the process (1) in the first image storing device as part of the temporary image.
